(19) United States
(12) Patent Application Publication
(10) Pub. No.: US 2020/0035029 A1
(43) Pub. Date: Jan. 30, 2020

(54) ENTERTAINMENT SYSTEM FOR A MOTOR VEHICLE AND METHOD FOR OPERATING AN ENTERTAINMENT SYSTEM

(71) Applicant: AUDI AG, Ingolstadt (DE)

(72) Inventors: Marcus KUEHNE, Beilngries (DE); Thomas ZUCHTRIEGEL, Munich (DE); Daniel PROFENDINER, Ingolstadt (DE)

(73) Assignee: AUDI AG, Ingolstadt (DE)

(21) Appl. No.: 16/478,774

(22) PCT Filed: Jan. 12, 2018
(86) PCT No.: PCT/EP2018/050710

§ 371 Date: Jul. 17, 2019

(30) Foreign Application Priority Data
Jan. 18, 2017 (DE) 10 2017 200 733.8

(51) Int. Cl. G06T 19/00; G02B 27/01; G06F 3/01

(52) U.S. Cl. CPC G06T 19/006; G02B 27/017; G02B 2027/0187; G02B 27/0179; G06F 3/011

(57) ABSTRACT

At least one visual output unit, wearable on the head, displays virtual elements from a prescribed virtual observation position. A control device evaluates sensor data characterizing a movement and/or spatial location of a motor vehicle actuates the visual output unit such that at least some of the virtual elements displayed by the visual output unit move relative to the virtual observation position in accordance with the movement of the motor vehicle and/or at least some of the virtual elements displayed by the visual output unit are arranged relative to the virtual observation position in accordance with the spatial location of the motor vehicle.

### CROSS REFERENCE TO RELATED APPLICATIONS

This application is the U.S. national stage of International Application No. PCT/EP2018/050710, filed Jan. 12, 2018, and claims the benefit thereof. The International Application claims the benefit of German Application No. 10 2017 200 733.8 filed on Jan. 18, 2017; both applications are incorporated by reference herein in their entirety.

### BACKGROUND

Described below is an entertainment system for a motor vehicle and a method for operating such an entertainment system.

The use of data glasses, for example of so-called augmented reality glasses, in motor vehicles is known per se. For example, DE 10 2013 005 342 A1 presents a method in which information is displayed on data glasses as a function of a sensed viewing direction of the driver during an autonomous driving operation.

During travel with a motor vehicle, vehicle occupants are as a result basically provided with the possibility of having a wide variety of contents displayed to them whether information and/or entertainment visual contents, by output devices which can be worn on the head such as e.g. by augmented reality glasses or virtual reality glasses.

The term virtual reality is used to refer to the representation and simultaneous perception of reality and its physical properties in an interactive virtual environment which is computer generated in real time. Mixing of the virtual reality and of real reality is called mixed or augmented reality. Augmented reality is understood to be the computer-supported augmentation of the perception of reality. This information can stimulate all human sensory modalities. However, augmented reality is also frequently understood to mean only the visual representation information, that is to say the supplementation of images on videos with additional computer-generated information or virtual objects by insertion/superimposition.

Special output devices, often referred to as head-mounted displays, are used to represent virtual realities and augmented realities. A head-mounted display is a visual output unit which can be worn on the head. It presents images either on a screen near to the eyes or projects them directly onto the retina. Such head-mounted displays are also often made available as wearable devices which are more or less like glasses. Depending on whether such visual output units which can be worn on the head are configured to display a virtual reality or augmented reality, they are also referred to as virtual reality glasses or augmented reality glasses. Virtual reality glasses usually visually shut off the wearer of the virtual reality glasses completely from his surroundings so that the wearer can only see the contents displayed by the virtual reality glasses but not his real environment. On the other hand, augmented reality glasses are designed in such a way that the wearer can still see his surroundings.

In the case of an autonomously driving motor vehicle, e.g. the driver could also have put on his virtual reality glasses, wherein in the case of non-autonomously driving vehicles the driver should have put on only augmented reality glasses so that he can still see his environment. In particular, when using virtual reality glasses vehicle occupants who have put on such virtual reality glasses may become nauseous. This frequently happens when the displayed virtual contents differ from what the sensory organs of the wearer of the virtual reality glasses supply in terms of information about the spatial location and movement of his body. The greater this deviation, the more probable it usually is that a wearer of such virtual reality glasses will feel nauseous. Respective individual sensitivities also play a role here. The same can basically also occur, albeit in an attenuated form, when wearing augmented reality glasses.

### SUMMARY

The method described herein provides a solution which permits vehicle occupants to have particularly realistic contents displayed to them by a visual output unit which can be worn on the head, without them becoming nauseous at the time.

The entertainment system for a motor vehicle described below includes at least one visual output unit which can be worn on the head and which is configured to display virtual elements from a prescribed virtual observation position. The visual output unit which can be worn on the head can be virtual reality glasses or else augmented reality glasses. In addition, it is also possible for the entertainment system to have a plurality of such visual output units which are worn on the head, whether augmented reality glasses or virtual reality glasses.

Furthermore, the entertainment system includes a control device which is configured to evaluate sensor data characterizing a movement and/or spatial location of the motor vehicle and to actuate the visual output unit which can be worn on the head in such a way that at least some of the virtual elements which are displayed by the visual output unit move relative to the virtual observation position in accordance with the movement of the motor vehicle, and/or at least some of the virtual elements which are displayed by the visual output unit are arranged relative to the virtual observation position in accordance with the spatial location of the motor vehicle.

The entertainment system is therefore able to use sensor data from one or more sensors in order to display to a wearer of the visual output unit which can be worn on the head what his sensory organs are supplying to him as information about his spatial location and movement, while the wearer of the visual output unit is seated in a motor vehicle and is moving along, in particular, with the motor vehicle. In this context there may be provision that virtual surroundings are displayed, for example, by the visual output unit, in which case all the virtual elements of the displayed virtual surroundings are continuously adapted in accordance with the locomotion and spatial location of the motor vehicle. If the motor vehicle therefore moves, for example, particularly fast in a forward direction, the wearer of the visual output unit moves particularly fast in a virtual fashion within displayed virtual surroundings. If, for example, the motor vehicle moves downhill, the wearer of the visual output unit also moves downhill within the virtual surroundings, and vice versa. Essentially all the information relating to the movement of the motor vehicle and to the location of the motor vehicle, and therefore also all the information relating to the actual movement of the wearer and the location of the wearer of the visual output unit during the actuation of the visual output unit is taken into account and correspondingly implemented.

Alternatively it is also possible that a type of virtual cinema screen, on which a film is projected, is displayed, for example, in a partial region by the visual output unit. For example further virtual elements can be displayed around the virtual cinema screen, which elements are continuously adapted in accordance with the locomotion of the motor vehicle and the location of the motor vehicle. The size ratio between the virtual cinema screen and the area which surrounds it and in which the virtual elements are adapted in accordance with the movement and location of the motor vehicle can be freely configurable here, for example, via a user interface of the entertainment system. Depending on how susceptible the wearer of the visual output unit is to so-called travel sickness or motion sickness, the body reaction which is referred to in specialist language as kinetosis, he can select the ratio in such a way that he does not become nauseous.

For example, it is also possible that the wearer of the visual output unit travels through a right-handed bend as he is sitting in the motor vehicle, while the surrounding real landscape is relatively boring. The visual output unit can then show, for example instead of a freeway which winds along a green empty meadow, a beautiful bend along a coast road with a spectacular view and impressive sunset. In this context, the visual output unit is actuated in such a way that the virtual coast road is displayed in a way that the motor vehicle travels along the real road along the bend. In particular, the acceleration sensation, that is to say the lateral acceleration of the wearer of the visual output unit during the cornering is therefore implemented at least essentially 1:1 during the display of the virtual coast road. The entertainment system therefore provides the possibility of displaying augmented or else virtual contents in a way that is particularly true to reality. In this context, the entertainment system ensures that a wearer of the visual output unit does not become queasy since the displayed virtual or augmented contents correspond at least in part or else completely to the sensory perceptions of the wearer of the visual output unit with respect to his spatial location and movement.

One advantageous embodiment provides that the control device is configured to evaluate sensor data characterizing a state of a wearer of the visual output unit which can be worn on the head, and to actuate the visual output unit as a function of these sensor data. For example, so-called biosensors can be accommodated on the vehicle side in a seat, in a steering wheel or the like, by which biosensors the state of the wearer of the visual output unit during travel can be continuously sensed with the motor vehicle. For example, as a result conclusions can be drawn about the wearer's emotional state or the wearer's energy level. The control device is configured to actuate the visual output unit as a function of these data or this information. The contents which are displayed by the visual output unit can therefore be adapted to the respective state of the wearer of the visual output unit. If the wearer is, for example, particularly unfit it could be that he reacts particularly sensitively if relatively large discrepancies occur between his sensory perceptions with respect to his location and movement and the contents displayed by the visual output unit. The visual output unit can be correspondingly actuated taking into account this fact, with the result that the displayed virtual or augmented contents are as far as possible congruent with the sensory impressions of the wearer of the visual output unit with respect to his location and movement.

A further advantageous embodiment provides that the control device is configured to evaluate data characterizing personal preferences of a wearer of the visual output unit which can be worn on the head, and to actuate the visual output unit as a function of these data. For example, the entertainment system can have a communications module by which there is access to one or more social media profiles of the wearer. Alternatively or additionally, it is, for example, also possible for various music databases of the wearer to be accessed. It is therefore possible, for example, for personal preferences of the wearer with respect to his music taste or else with respect to preferred holiday destinations or the like to be taken into account in the displaying of virtual or augmented contents by the visual output unit. By musically underscoring and/or selecting the displayed contents in a way which matches the wearer's preferences, the wearer can be influenced in such a way that he becomes less nauseous or not nauseous at all.

According to a further advantageous embodiment there is provision that the entertainment system has exclusively sensors which are remote from the vehicle and have the purpose of sensing the movement of the motor vehicle and/or sensing the spatial location of the motor vehicle and/or sensing the state of a wearer of the visual output unit which can be worn on the head. As a result, the entire entertainment system with associated sensors can be embodied as a type of retrofit kit. The entertainment system can essentially be retrofitted independently of the motor vehicle at any time in such a way as to achieve the functionalities and advantages already mentioned above. Therefore, for example even relatively old vehicle models can be readily retrofitted by the entertainment system.

According to one alternative advantageous embodiment there is provision that the entertainment system has exclusively sensors which are integrated on the vehicle side and have the purpose of sensing the movement of the motor vehicle and/or sensing the spatial location of the motor vehicle and/or sensing the state of a wearer of the visual output unit which can be worn on the head. Part of the entertainment system, in particular the sensors, can therefore be integrated fixedly in a motor vehicle. Alternatively it is also possible for the sensors themselves or some of the sensors themselves to not even be part of the entertainment system, wherein the entertainment system merely has an interface via which it has access to the necessary sensor data.

In this context it is particularly advantageous if the entertainment system has an interface which is compatible with a vehicle-side diagnostic bushing, for transmitting the sensor data to the control device. This interface can be, for example, what is referred to as a OBD dongle which can be plugged into an OBD interface which is usually present in all modern vehicles in order to access the sensor data. In this context there can also be provision that the control device is a control device which is external to the vehicle and is, in particular, integrated into the visual output unit which can be worn on the head. The visual output unit can have, for example, a Bluetooth module by which the sensor data can be received by the OBD dongle.

According to a further advantageous embodiment there is provision that the control device is configured to select music files as a function of the movement of the motor vehicle, the state and/or the personal preferences of a wearer of the visual output unit which can be worn on the head, and to actuate a loudspeaker for outputting the selected music files. For example, the music device can be adapted, to the movement of the motor vehicle, the state and/or the personal taste of the wearer of the visual output unit, for example, with respect to the so-called beats per minute and also with respect to further parameters. The contents which are displayed by the visual output unit can as a result be underscored musically particularly well to the current locomotion with the motor vehicle, the state of the wearer and/or the personal taste of the wearer. On the one hand, this can contribute to reducing, or even eliminating entirely, kinetosis of the wearer of the visual output unit. On the other hand, this can also simply contribute to additionally beautifying and enhancing the visual perception.

In the method for operating an entertainment system virtual elements are displayed from a prescribed virtual observation position by at least one visual output unit which can be worn on the head, wherein sensor data characterizing a movement and/or a spatial location of a motor vehicle are evaluated by a control device, and the visual output unit is actuated so that at least some of the virtual elements which are displayed by the visual output unit move relative to the virtual observation position in accordance with the movement of the motor vehicle, and/or at least some of the virtual elements which are displayed by the visual output unit are arranged relative to the virtual observation position in accordance with the spatial location of the motor vehicle. Advantageous refinements of the entertainment system are to be considered advantageous refinements of the method and vice versa. In particular, the entertainment system is able to carry out the method.

Further advantages, features and details can be found in the following description of exemplary embodiments and with reference to the drawing. The features and combinations of features which are specified above in the description as well as the features and combinations of features which are presented below in the description of the figures and/or in the figures alone can be used not only in the specified combination but also alone without departing from the scope of the invention.

### BRIEF DESCRIPTION OF THE DRAWINGS

These and other aspects and advantages will become more apparent and more readily appreciated from the following description of the exemplary embodiment, taken in conjunction with the accompanying drawings of which:

FIG. 1 is a schematic illustration of an entertainment system for a motor vehicle in which a visual output unit can be worn on the head, in the form of virtual reality glasses, and control device for actuating the virtual reality glasses, which control device is configured to actuate the virtual reality glasses as a function of a wide variety of sensor data characterizing the movement and location of the motor vehicle;

FIG. 2 is a schematic side view of a motor vehicle, wherein the wearer of the virtual reality glasses is illustrated; and

FIG. 3 is a schematic illustration of a virtual coast road displayed by the virtual reality glasses.

### DETAILED DESCRIPTION OF THE PREFERRED EMBODIMENT

In the figures, identical or functionally identical elements are provided with the same reference symbols.

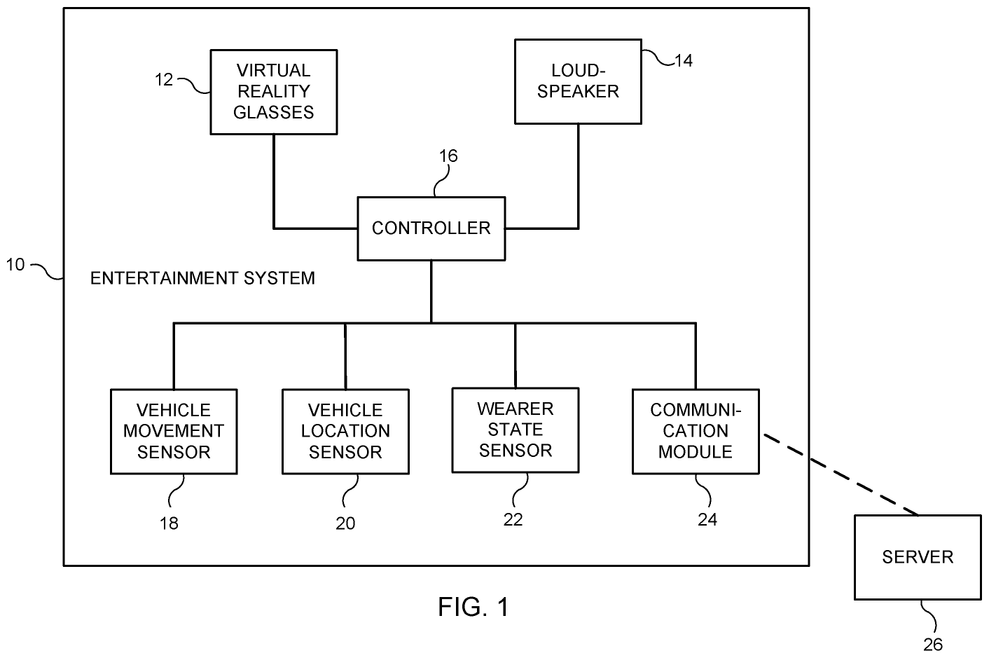

An entertainment system 10 for a motor vehicle (not illustrated in more detail) is shown in a schematic illustration in FIG. 1. The entertainment system 10 includes a visual output unit in the form of a pair of virtual reality glasses 12, a loudspeaker 14 and a controller 16 which is configured to actuate both the virtual reality glasses 12 and the loudspeaker 14. Furthermore, the entertainment system 10 has a sensor 18 which is configured to sense a movement of the motor vehicle (not illustrated here), in particular translational movements and also rotational movements about the longitudinal axis, transverse axis and vertical axis of the vehicle. Furthermore, the entertainment system 10 has a sensor 20 by which the location of the motor vehicle can be determined, that is to say, for example, whether the motor vehicle is traveling straight ahead uphill or is traveling downhill. In addition, the entertainment system 10 has a sensor 22 by which very different information and data relating to the state of the wearer of the virtual reality glasses 12 can be collected. Finally, the entertainment system 10 also has a communication module 24 which can set up a data connection to one or more servers 26 on which information relating to a wide variety of preferences of the wearer of the virtual reality glasses 12 is stored.

In the present exemplary embodiment of the entertainment system 10 shown in FIG. 1, the system is embodied as a type of retrofit kit which can be integrated without difficulty essentially in any design of the motor vehicle. Alternatively it is, however, also possible for the entertainment system 10 to have, for example, merely only the virtual reality glasses 12 and controller 16, wherein all the other elements 14, 18, 20, 22, 24 do not have to be part of the entertainment system 10 itself. For example, it is possible for the loudspeaker 14 or for other loudspeakers (not illustrated here) as well as the sensors 18, 20, 22 and the communications module 24 to be a fixedly installed component of a motor vehicle.

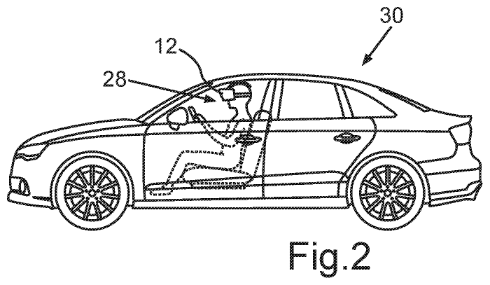

FIG. 2 illustrates a wearer 28 of the virtual reality glasses 12 which is seated in a motor vehicle 30. The wearer 28 can be, for example, the driver of the motor vehicle 30 but also a front seat passenger.

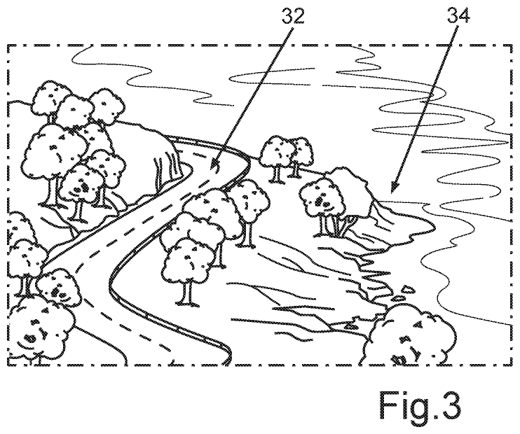

FIG. 3 illustrates a virtual coast road 32 which runs along a virtual coast 34. This virtual coast road 32 which runs along the virtual coast 34 is displayed by the virtual reality glasses 12. A particular challenge when displaying such virtual contents is that, on the one hand, the displayed virtual surroundings appear particularly realistic and, on the other hand, at the same time the wearer 28 does not become nauseous. The latter can be avoided, in particular, by virtue of the fact that the sensory impressions of the wearer 28 with respect to his movement and his location do not differ, or differ only to a small extent, from the visual sensory impressions with respect to the displayed virtual surroundings, in this case therefore the virtual coast road 32.

The controller 16 is configured to evaluate sensor data from the sensors 18, 20 characterizing a movement and respective spatial location of the motor vehicle 30, and to actuate the virtual reality glasses 12 in such a way that a displayed virtual journey along the virtual coast road 32 corresponding to the real locomotion of the motor vehicle 30 is displayed. The wearer 28 sees the coast road 32 from a prescribed virtual observation position through the virtual reality glasses 12 as if he were looking onto the coast road 32 from a virtual motor vehicle (not illustrated in any more detail) while he is moving along the coast road 32 in a virtual fashion. The coast 34 and further elements of the virtual scenery (not denoted here in more detail) are displayed here by the virtual reality glasses 12 in such a way that the entire virtual scenery appears to move past the wearer 28 as he actually moves along with the real motor vehicle 30.

If the wearer 28 therefore moves, with the motor vehicle 30, for example along a precipitous road with many bends, he also travels downhill along the virtual coast road 32 and through a multiplicity of bends. The information on the position and movement that senses of the wearer 28 supply during the real journey with the motor vehicle 30 therefore corresponding at least essentially to the visual sensory impressions which the wearer 28 experiences owing to the displaying of the virtual coast road 32 by the virtual reality glasses 12.

Moreover, the controller 16 is configured to evaluate sensor data which characterize a state of the wearer 28 and which are made available by the sensor 22, and to actuate the virtual reality glasses 12 as a function of these sensor data. In addition to the one abovementioned sensor 22, a multiplicity of sensors 22 can also be arranged, for example, on the virtual reality glasses 12 themselves or else in the motor vehicle 30. Therefore, a wide variety of information can be acquired, for example, relating to the emotional state and/or the energy level of the wearer 28 and taken into account during the actuation of the virtual reality glasses 12. If the wearer 28 happens, for example, to be relatively tired, particularly varied virtual surroundings can be displayed to him all around the coast road 32. Essentially, contents which are matched to different states of the wearer 28 can be displayed by the virtual reality glasses 12.

In addition it is also possible for the controller 16 to take into account personal preferences of the wearer 28 and to actuate the virtual reality glasses 12 correspondingly. For this purpose, data which are received from the server 26 by the communications module 14 are evaluated. The server 26 can be, for example, part of a social media platform or else of a music platform or the like. Different preferences of the wearer 28, for example with respect to his favorite holiday destinations, his music taste and the like can be taken into account. It is therefore possible, on the one hand, for the virtual reality glasses 12 to be actuated in such a way that such contents which the wearer 28 finds particularly interesting or beautiful are displayed visually. Moreover, the controller 16 can actuate the loudspeaker 14 in such a way that particularly favorite pieces of music of the wearer 28 are played in order to underscore the virtual scenery, that is to say for example the displayed virtual coast road 32.

The entertainment system 10 is therefore, on the one hand, able to display during the journey with a motor vehicle 30 virtual contents which appear particularly realistic and are adapted to the taste of the wearer 28. On the other hand, by taking into account the sensor data of the sensors 18, 20, 22, it is possible to avoid or at least reduce the occurrence of nausea on the part of the wearer 28 of the virtual reality glasses 12.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. An entertainment system for a motor vehicle, comprising
at least one visual output unit configured to be worn on a head of a user and to display virtual elements from a prescribed virtual observation position; and
a control device configured to evaluate first sensor data characterizing at least one of a movement and a spatial location of the motor vehicle and to actuate the at least one visual output unit so that at least some of the virtual elements are displayed by the visual output device with at least one of movement relative to the virtual observation position in accordance with the movement of the motor vehicle and arrangement of at least some of the virtual elements relative to the virtual observation position in accordance with the spatial location of the motor vehicle.

11. The entertainment system as claimed in claim 10, wherein the control device is configured to evaluate second sensor data characterizing a state of the user of the virtual output unit, and to actuate the visual output unit as a function of the second sensor data.

12. The entertainment system as claimed in claim 11, wherein the control device is configured to evaluate preference data characterizing personal preferences of the user of the visual output unit, and to actuate the visual output unit as a function of the preference data.

13. The entertainment system as claimed in claim 12, further comprising sensors separate from the vehicle and configured to sense the at least one of the movement of the motor vehicle and the spatial location of the motor vehicle, and the state of the user of the visual output unit.

14. The entertainment system as claimed in claim 12, further comprising sensors integrated in the motor vehicle and configured to sense the at least one of the movement of the motor vehicle and the spatial location of the motor vehicle, and the state of the user of the visual output unit.

15. The entertainment system as claimed in claim 14, wherein the motor vehicle has a vehicle-side diagnostic socket,
wherein the control device is integrated into the visual output unit, and
wherein the entertainment system further comprises an interface compatible with the vehicle-side diagnostic socket and configured to transmit the first and second sensor data to the control device.

16. The entertainment system as claimed in claim 11, wherein the visual output unit includes one of virtual reality glasses and augmented reality glasses.

17. The entertainment system as claimed in claim 11, wherein the control device is configured to
select music files as a function of at least one of the movement of the motor vehicle, the state of the user and the personal preferences of the user of the visual output unit, and
actuate a loudspeaker for outputting the music files.

18. The entertainment system as claimed in claim 11, further comprising sensors separate from the vehicle and configured to sense the at least one of the movement of the motor vehicle and the spatial location of the motor vehicle, and the state of the user of the visual output unit.

19. The entertainment system as claimed in claim 11, further comprising sensors integrated in the motor vehicle side configured to sense the at least one of the movement of the motor vehicle and the spatial location of the motor vehicle, and the state of the user of the visual output unit.

20. The entertainment system as claimed in claim 19, wherein the motor vehicle has a vehicle-side diagnostic socket,
wherein the control device is integrated into the visual output unit, and
wherein the entertainment system further comprises an interface compatible with the vehicle-side diagnostic socket and configured to transmit the first and second sensor data to the control device.

21. A method for operating an entertainment system, comprising:
displaying virtual elements from a prescribed virtual observation position by at least one visual output unit configured to be worn on a head of a user;
evaluating first sensor data characterizing at least one of a movement and a spatial location of a motor vehicle by a control device, and
actuating the visual output unit so that at least some of the virtual elements are displayed by the visual output unit with at least one of movement relative to the virtual observation position in accordance with the movement of the motor vehicle and arrangement of at least some of the virtual elements relative to the virtual observation position in accordance with the spatial location of the motor vehicle.

22. The method as claimed in claim 21, further comprising:
evaluating second sensor data characterizing a state of the user of the virtual output unit; and
actuating the visual output unit as a function of the second sensor data.

23. The method as claimed in claim 22, further comprising:
evaluating preference data characterizing personal preferences of the user of the visual output unit; and
actuating the visual output unit as a function of the preference data.

24. The method as claimed in claim 23, further comprising:
selecting music files as a function of at least one of the movement of the motor vehicle, the state of the user and the personal preferences of the user of the visual output unit; and
actuating a loudspeaker for outputting the music files.

25. The method as claimed in claim 21, further comprising:
evaluating preference data characterizing personal preferences of the user of the visual output unit; and
actuating the visual output unit as a function of the preference data.

26. The method as claimed in claim 21, further comprising:
selecting music files as a function of at least one of the movement of the motor vehicle, a state of the user and personal preferences of the user of the visual output unit; and
actuating a loudspeaker for outputting the music files.
